(19) United States
(12) Patent Application Publication
(10) Pub. No.: US 2010/0130198 A1
(43) Pub. Date: May 27, 2010

(54) Remote processing of multiple acoustic signals

(75) Inventors: Kenneth S. Kannappan, Palo Alto, CA (US); Steven F. Burson, Darby, MT (US)

Correspondence Address: PLANTRONICS, INC.;IP Department/Legal, 345 ENCINAL STREET, P.O. BOX 635, SANTA CRUZ, CA, 95060-0635, US

(73) Assignee: Plantronics, Inc.

(21) Appl. No.: 11/241,472

(22) Filed: Sep. 29, 2005

(51) Int. Cl. H04W 4/00; H04B 15/00

(52) U.S. Cl. 455/434; 455/63.1

(57) ABSTRACT

Systems and methods for remote digital signal processing of multiple signals are disclosed. The system generally includes a mobile communication device with a first microphone for receiving a first acoustic signal and a second microphone for receiving a second acoustic signal. The first acoustic signal and the second acoustic signal are transmitted to a processing station for processing using a wireless protocol.

### BACKGROUND OF THE INVENTION

Headset and other telephonic device designs must address background noise caused by a variety of noise sources in the user's vicinity. Such background noise may include, for example, people conversing nearby, wind noise, machinery noise, ventilation noise, loud music and intercom announcements in public places. These noise sources may either be diffuse or point noise sources. In the prior art, such acoustic interference is normally managed by (1) the use of a long microphone boom, which places the microphone as close as possible to the user's mouth, (2) a voice tube, which has the same effect as a long boom, or (3) a noise canceling microphone, which enhances the microphone response in one direction oriented towards the user's mouth and attenuates the response from the other directions. However, these solutions may not be compatible with stylistic and user comfort requirements of the headset. When using noise-canceling microphones, if the microphone is not properly positioned the noise reducing mechanism effectiveness is reduced. In these cases, additional background noise reduction is required in the microphone output signal.

In addition to point noise sources and diffuse noise sources, headsets and other telephonic device designs used for telephony must deal with the acoustic response from device speakers being detected by the device microphone and then sent back to the far-end speaker. Following delays inherent in the telecommunications circuit, this acoustic response may be detected by the far-end user as an echo of their own voice. As used herein, the “transmit signal” refers to the audio signal from a near end user, e.g. a headset wearer, transmitted to a far-end listener. The “receive signal” refers to the audio signal received by the headset wearer from the far-end talker. In the prior art, one solution to the echo problem is to ensure the acoustic isolation from the headset speaker to the headset microphone is sufficient to render any residual echo imperceptible. For example, one solution is to use a headset with a long boom to place the microphone near the user's mouth.

However, such a headset may be uncomfortable to wear or too restrictive in certain environments. Furthermore, many applications require a headset design that cannot achieve the acoustic isolation required, such as a headset with a very short microphone boom used in either cellular telephony or Voice over Internet Protocol (VoIP), or more generally Voice over Packet (VoP) applications. In these applications, the delay through the telecommunications network can be hundreds of milliseconds, which can make even a small amount of acoustic echo annoying to the far-end user. The required acoustic isolation is more difficult to achieve with boomless headsets, hands-free headsets, speaker-phones, and other devices in which a microphone and speaker may be in close proximity. One solution described in the prior art is to utilize an echo cancellation technique to reduce the acoustic echo. Such techniques are discussed for example, in U.S. Pat. No. 6,415,029 entitled “Echo Canceller and Double-Talk Detector for Use in a Communications Unit.” Noise reduction, echo cancellation, and other similar techniques may be implemented using digital signal processing (DSP) techniques.

In the prior art, DSP audio processing techniques such as those used in noise reduction algorithms or voice recognition are generally divided into two categories: imbedded device processing and server based processing. In imbedded device processing, the signal processing algorithms are typically executed “locally” on a relatively small mobile device such as a headset or cell phone that has limited size and battery power. Due to their limited size and battery power, such devices require the use of relatively small processors and have limited memory resources. As a result, the ability of such devices to perform memory intensive signal processing is limited. Furthermore, the mobile devices are typically much more cost sensitive than servers and typically only process signals for one device.

The imbedded device systems utilize simpler algorithms that can execute on the limited resources. These simpler algorithms are often limited to single inputs with nonrobust techniques. For example, FIG. 1 illustrates a simplified block diagram of the components of a prior art headset 200. Headset 200 may include a headset controller 226 that comprises a processor, memory and software. The headset controller 226 receives input from headset user interface 230 and manages audio data received from microphone 212 and audio from a far-end user sent to speaker 224. The headset controller 226 further interacts with wireless communication module 234 to transmit and receive signals between the headset 200 and a base station.

Wireless communication module 234 includes an antenna system 236. The headset 200 further includes a power source such as a rechargeable battery 228 which provides power to the various components of the headset. Wireless communication module 234 may use a variety of wireless communication technologies. The headset user interface 230 may include a multifunction power, volume, mute, and select button or buttons. Other user interfaces may be included on the headset, such as a link active/end interface.

The headset 200 includes a microphone 212 for receiving an acoustic signal. Microphone 212 is coupled to an analog to digital (A/D) converter 26 which outputs a digitized signal 217. Digitized signal 217 is provided to a digital signal processor (DSP) 238 for processing to remove background noise utilizing a noise reduction algorithm. A processed signal is output from noise reducer for transmission to a far-end user via wireless communication module 234.

The imbedded device processors do not have the resources to execute complex audio processing algorithms in real time. Such devices perform limited processing algorithms on the device and transmit the processed signal to a location remote from the device. The devices did not transmit multiple channels of acoustic data for remote processing. For remote clients on server based systems there were not enough channels or bandwidth available to transmit multiple channels of acoustic information. As a result, although server based processors have the capacity to run complex and robust algorithms, the algorithms were constrained to processing a single input channel.

With server based processing, the signals are processed by a server where size and power are not typically limitations and more robust algorithms can be used. The servers service multiple clients or can be purpose built for a single client device. The servers are not as cost sensitive as their imbedded device counterparts.

Many robust algorithms running on servers advantageously process multiple input signals. Although offering greater processing power, the server-based processing systems are constrained to operate on fixed systems where large processors are available, such as PC based systems. These systems can execute complex algorithms processing multiple inputs but were used with stationary rather than wireless mobile devices.

Accordingly, there has been a need for improvements in the processing of multiple acoustic signals. More specifically, there has been a need for improved systems and methods for processing of multiple acoustic signals in wireless products.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a simplified block diagram of the components of a prior art wireless headset implementing limited signal processing at the headset.

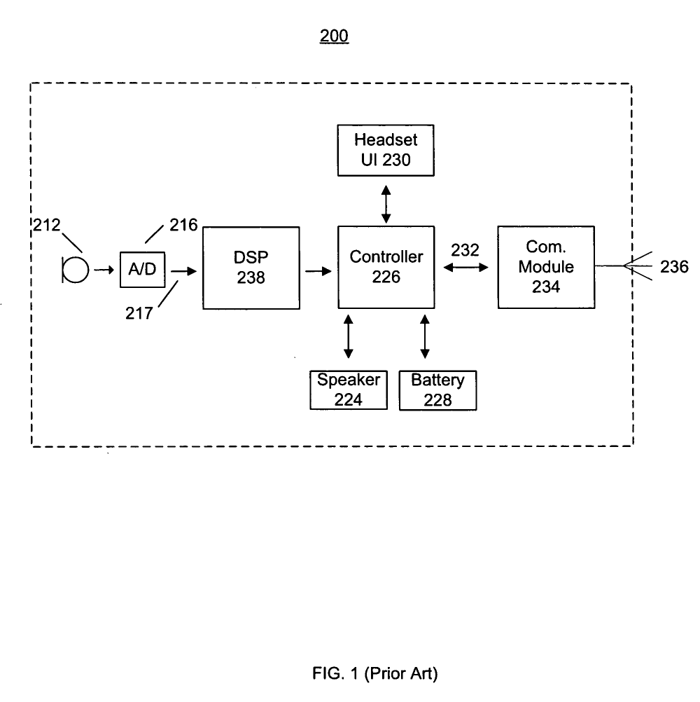

FIG. 2 illustrates a system for remote processing of multiple acoustic signals in one example of the invention.

FIG. 3 illustrates a simplified block diagram of the components of the mobile communication device shown in FIG. 2.

FIG. 4 illustrates a simplified block diagram of the components of the processing station shown in FIG. 2.

FIG. 5 illustrates one example of signal processing performed by a processing station.

FIG. 6 illustrates examples of telephone networks in which the present invention may be implements.

### DESCRIPTION OF SPECIFIC EMBODIMENTS

Methods and apparatuses for remote digital signal processing of multiple acoustic signals are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

Generally, this description describes a method and apparatus for transmitting, receiving, and processing multiple acoustic signals remotely from a wireless mobile communication device (also referred to herein as a client or remote device) at which the acoustic signals are received. The present invention is applicable to a variety of different types of mobile communication devices, including headsets and cell phones. While the present invention is not necessarily limited to such devices, various aspects of the invention may be appreciated through a discussion of various examples using this context.

According to an example of the invention, the system includes a wireless mobile communication device which transmits signals from multiple microphones to a server and processes them in real time or near real time at the server. Multiple channels of information are transmitted from the remote device to a processing station (also referred to herein as a fixed base or server) where the signals can be processed. The 802.11a and Bluetooth standards are two examples of wireless communication protocols that may be used. In one example, the system transmits each acoustic signal on a separate channel. In a further example, the system may use a single channel to transmit multiple acoustic signals.

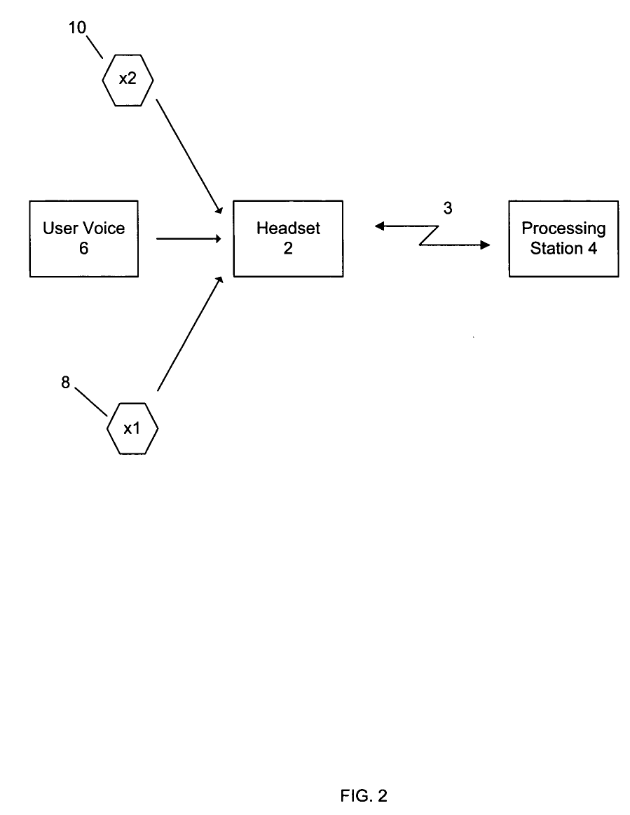

FIG. 2 illustrates a system for remote processing of multiple acoustic signals in one example of the invention. The system includes a wireless headset 2, processing station 4, and a wireless protocol link 3 between the headset 2 and processing station 4. For example, wireless protocol link 3 may be any low power, high quality RF link. In one particular example, wireless protocol link 3 is a Bluetooth link.

Wireless headset 2 may be boomless or include a short or regular length boom. Wireless headset 2 comprises two or microphones for receiving acoustic input and an audio speaker for outputting a voice output. Any wireless hands free device, handset or other telephonic device may be used in the invention in place of a wireless headset 2. In operation, the wireless headset microphones receive undesired input from noise sources in addition to a desired user voice 6. For example, as shown in FIG. 2, noise sources may be represented as a noise source x1 8 and a noise source x2 10. Noise source x1 8 and noise source x2 10 may be either point noise sources or general background noise. In addition, the output of a far end user voice at the headset speaker may present an additional noise source at the headset microphones.

Processing station 4 is a computing device. Processing station 4 may be any electronic device capable of performing the processing functions described herein. For example, processing station 4 may be a personal computer, cellular telephone, PDA, or a base station coupled to a landline telephone.

Wireless headset 2 transmits multiple acoustic signals to processing station 4 over wireless protocol link 3 for processing. For example, processing station 4 may perform noise reduction processing. By performing noise reduction processing at the processing station 4, the noise reduction power requirement is located at processing station 4, where processing power is greater relative to headset 2. Battery requirements remain low in headset 2.

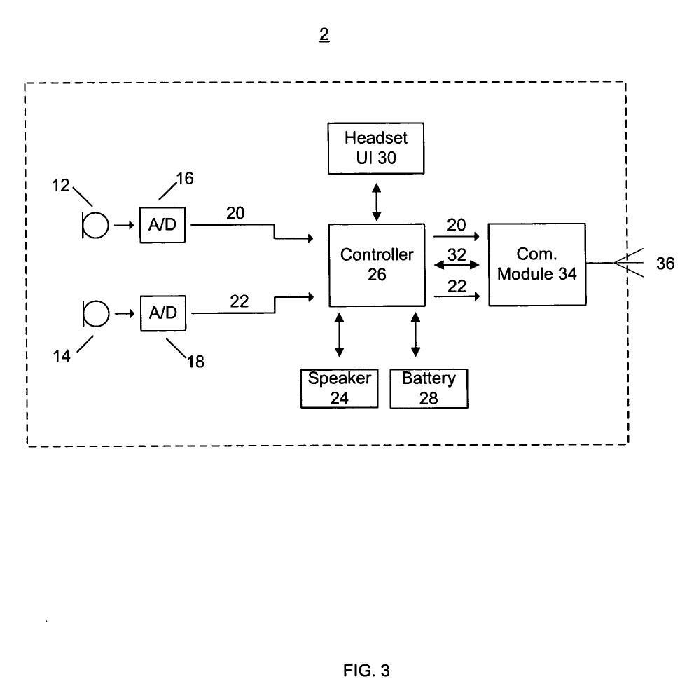

FIG. 3 illustrates a simplified block diagram of the components of the headset 2 shown in FIG. 2. Headset 2 may include a headset controller 26 that comprises a processor, memory and software to implement functionality as described herein. The headset controller 26 receives input from headset user interface 30 and manages audio data received from microphones 12 and 14 and audio from a far-end user sent to speaker 24. The headset controller 26 further interacts with wireless communication module 34 (also referred to herein as a transceiver) to transmit and receive signals between the headset 2 and processing station 4 employing comparable communication modules. The term “module” is used interchangeably with “circuitry” herein.

Wireless communication module 34 includes an antenna system 36. The headset 2 further includes a power source such as a rechargeable battery 28 which provides power to the various components of the headset. In a further example, the wireless communication module 34 may include a controller which controls one or more operations of the headset 2. Wireless communication module 34 may be a chip module. Referring again to FIG. 2, processing station 4 includes a corresponding wireless communication module to allow communication or linking between the processing station 4 and the headset 2.

Wireless communication module 34 may use a variety of wireless communication technologies. For example, wireless communication module 34 is a Bluetooth, Digital Enhanced Cordless Telecommunications (DECT), or IEEE 802.11 communications module configured to provide the wireless communication link. Bluetooth, DECT, or IEEE 802.11 communications modules require the use of an antenna at both the receiving and transmitting end. In one example, headset antenna system 36 is a diversity antenna.

The headset user interface 30 may include a multifunction power, volume, mute, and select button or buttons. Other user interfaces may be included on the headset, such as a link active/end interface. It will be appreciated that numerous other configurations exist for the user interface. The particular button or buttons and their locations are not critical to the present invention.

The headset 2 includes a microphone 12 and a microphone 14 for receiving audio information. For example, microphone 12 and microphone 14 may be utilized as a linear microphone array. In a further example, the microphone array may comprise more than two microphones. Microphone 12 and microphone 14 are installed at the lower end of the headset boom in one example.

Use of two or more microphones is beneficial to facilitate generation of high quality speech signals since desired vocal signatures can be isolated and destructive interference techniques can be utilized. Use of microphone 12 and microphone 14 allows phase information to be collected. Because each microphone in the array is a fixed distance relative to each other, phase information can be utilized to better pinpoint the location of noise sources and reduce noise. Although the use of two microphones may be described herein, headset 2 may be implemented with any number of microphones.

Microphone 12 and microphone 14 may comprise either onini-directional microphones, directional microphones, or a mix of omni-directional and directional microphones. Microphone 12 and microphone 14 detect the voice of a near end user which will be the primary component of the audio signal, and will also detect secondary components which may include background noise and the output of the headset speaker.

Each microphone in the microphone array at the headset is coupled to an analog to digital (A/D) converter. Referring again to FIG. 3, microphone 12 is coupled to A/D converter 16 and microphone 14 is coupled to A/D converter 18. The analog signal output from microphone 12 is applied to A/D converter 16 to form individual digitized signal 20. Similarly, the analog signal output from microphone 14 is applied to A/D converter 18 to form individual digitized signal 22. A/D converter 16 and 18 include anti-alias filters for proper signal preconditioning.

Those of ordinary skill in the art will appreciate that the inventive concepts described herein apply equally well to microphone arrays having any number of microphones and array shapes which are different than linear. The impact of additional microphones on the system design is the added cost and complexity of the additional microphones and their mounting and wiring, plus the added A/D converters, plus the added processing capacity (processor speed and memory) required to perform processing and noise reduction functions on the larger array.

Digitized signal 20 and digitized signal 22 output from A/D converter 16 and A/D converter 18 are transmitted to processing station 4 using wireless communication module 34. In one example, the wireless network over which headset 2 and the processing station communicate is referred to as a personal area network (PAN). Both the wireless communication module 34 and corresponding wireless communication module at charging station 4 have the capability to transmit and receive signals over the PAN. The PAN may use a variety of transmission networks, including radio-frequency networks. For example, the radio-frequency network could employ Bluetooth, 802.11, or DECT standards based communication protocols. However, the wireless network is not limited to PANs or these communication protocols.

In one example, wireless communication module 34 communicates over an RF network employing the Bluetooth standard with corresponding Bluetooth modules at the processing station. The Bluetooth specification, version 2.0, is hereby incorporated by reference. A prescribed interface such as Host Control Interface (HCI) is defined between each Bluetooth module. Message packets associated with the HCI are communicated between the Bluetooth modules. Control commands, result information of the control commands, user data information, and other information are also communicated between Bluetooth modules. For example, the Bluetooth network may use the headset profile or a variation thereof.

In one example, processing station 4 is a Bluetooth master unit and headset 2 is a Bluetooth slave unit. Processing station 4 assigns channel access priorities to headset 2 and sets the frequency-hopping sequence the headset 2 tunes to. Processing station 4 permits headset 2 to transmit by allocating slots for acoustic data traffic. Headset 2 contains a unique Bluetooth device address, which is a 48-bit IEEE address. Point-to-point time division duplex (TDD) communication is used between the headset 2 and the processing station 4. A channel is divided into time slots, each of which is 625 microseconds in length. Processing station 4 utilizes up to three simultaneous synchronous connection-oriented (SCO) fill-duplex voice links with headset 2.

In a further example, wireless communication module 34 communicates over a RF network employing the DECT standard with corresponding DECT modules at the processing station. The DECT standard is a wireless protocol designed to provide wireless communications for telecommunications equipment such as cordless phones. The DECT standard is promulgated by the European Telecommunications Standards Institute. It operates in the 1.8 GHz radio band, employing Time Division Multiple Access (TDMA) technology. DECT operates at speeds of 2 Mbps and is ideal for use in voice applications. DECT offers the advantages of low power consumption, enabling smaller batteries to be used in a wireless headset. In addition to offering multiple channels, DECT offers varying bandwidths by combining multiple channels into a single barrier.

In a further example, wireless communication module 34 uses an IEEE 802.11 (“802.11”) standardized network to transmit voice either within an enterprise (intranet) or over a wider area (internet) using VoIP technologies or converging a LAN with the telephony system within a company to provide wireless access to the public switched telephone network (PSTN) system.

The IEEE 802.11 wireless LAN standard addresses the basic transport of LAN data over a wireless medium. There are currently three variations of 802.11: IEEE 802.11a (5 GHz, 54 Mbps), IEEE 802.11b (2.4 GHz, 11 Mbps), and IEEE 802.11g (2.4 GHz, 54 Mbps). Streaming media applications, such as voice communication require a reliable and predictable data stream. Such reliability and predictability is provided by the ability to classify traffic and prioritize time-sensitive classes of traffic, referred to as QoS (Quality of Service). QoS is addressed by 802.11e. It includes more effective channel management, provides better power management for low power devices, specifies a means to set up side links to other 802.11 devices while simultaneously communicating with an 802.11 AP, and provides improvements to the polling algorithms used by access points.

802.11 LANs use a distribution system, also referred to as a backbone, to forward frames to their destination when several access points are connected to form a large coverage area, requiring communication between each access point to track the movements of mobile stations. In many embodiments Ethernet is utilized. The access points act as bridges between the wireless world and the wired world. Each access point has at least two network interfaces: a wireless interface that understands 802.11 and a second interface with wired networks. Typically, the wired interface is an Ethernet port and/or WAN port. Access points typically have a TCP/IP interface. The mobile stations may, for example, be wireless headsets.

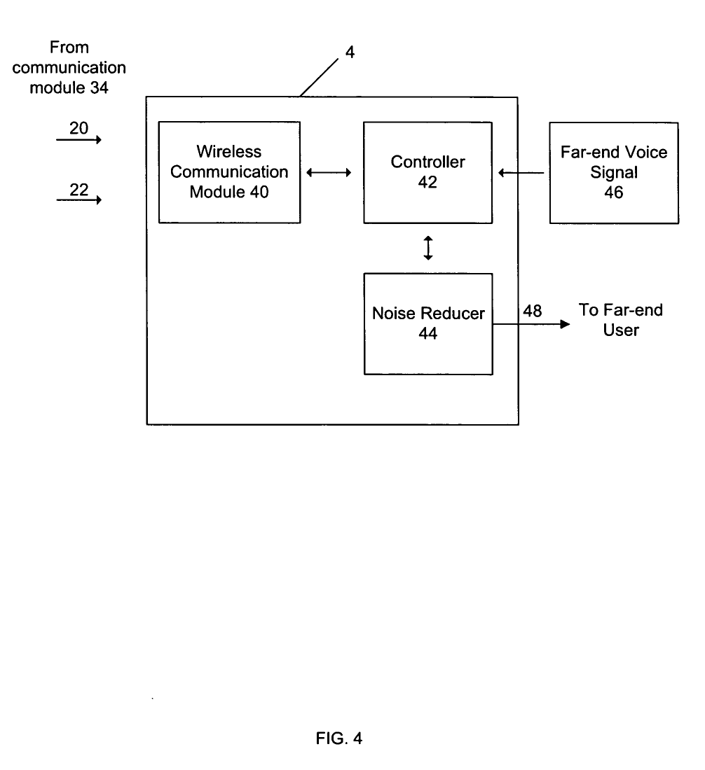

FIG. 4 illustrates a simplified block diagram of the components of the processing station 4 shown in FIG. 2. Processing station 4 includes a wireless communication module 40, controller 42, and noise reducer 44.

Digitized signal 20 and digitized signal 22 are received by wireless communication module 40 from wireless communication module 34 and provided to noise reducer 44 by controller 42. Noise reducer 44 processes digitized signal 20 and digitized signal 22 to remove background noise utilizing a noise reduction algorithm. A processed signal 48 is output from noise reducer 44 for transmission to a far-end user.

Digitized signal 20 and digitized signal 22 corresponding to the audio signal detected by microphone 12 and microphone 14 may comprise several signal components, including user voice 6 and noise source x1 8 and noise source x2 10. There is a time delay between digitized signal 20 and digitized signal 22 output resulting from the different physical location of microphone 12 and microphone 14 at headset 2.

Noise reducer 44 may comprise any combination of several noise reduction techniques known in the art to enhance the vocal to non-vocal signal quality and provide a final processed digital output signal. Noise reducer 44 utilizes both digitized signal 20 and digitized signal 22 to maximize performance of the noise reduction algorithms. Noise reducer 44 may also utilize a far-end voice signal 46 in the noise reduction algorithms. Each noise reduction technique may address different noise artifacts present in the voice and noise signal. Such techniques may include, but are not limited to noise subtraction, spectral subtraction, dynamic gain control, and independent component analysis.

Referring to FIG. 2 and FIG. 4, in noise subtraction, the noise source components x1 8 and x2 10 are processed and subtracted from digitized signal 20 and digitized signal 22. These techniques include several Widrow-Hoff style noise subtraction techniques where the voice amplitude and the noise amplitude are adaptively adjusted to minimize the combination of the output noise and the voice aberrations. A model of the noise signal produced by noise source x1 8 and noise source x2 10 is generated and utilized to cancel the noise signal in the signals detected at the headset 2. The synthesized noise model of noise source x1 8 and x2 10 represents the combination of the noise sources, where all the noise sources combined are treated as one noise source.

In spectral subtraction, the voice and noise components of digitized signal 20 and digitized signal 22 are decomposed into their separate frequency components and adaptively subtracted on a weighted basis. The weighting may be calculated in an adaptive fashion using an adaptive feedback loop.

Noise reducer 44 further uses digitized signal 20 and digitized signal 22 in Independent Component Analysis, including Blind Source Separation (BSS), which is particularly effective in reducing noise.

Noise reducer 44 may also utilize dynamic gain control, “noise gating” the output during unvoiced periods. When the user of headset 2 is silent, there is no output to the far end and therefore the far end user does not hear noise sources x1 8 and x2 10. The noise reduction techniques described herein are for example, and additional techniques known in the art may be utilized.

In one example application, headset 2 is an 802.11a VOIP headset operating in a high background noise environment. One headset microphone is placed near the mouth to pick up the desired voice signal but also detects undesired ambient noise. A second headset microphone is placed to primarily detect ambient noise. The signals from both of these microphones are sent to a processing station where the ambient noise signal is subtracted from the voice signal to produce a clean voice signal for transmission.

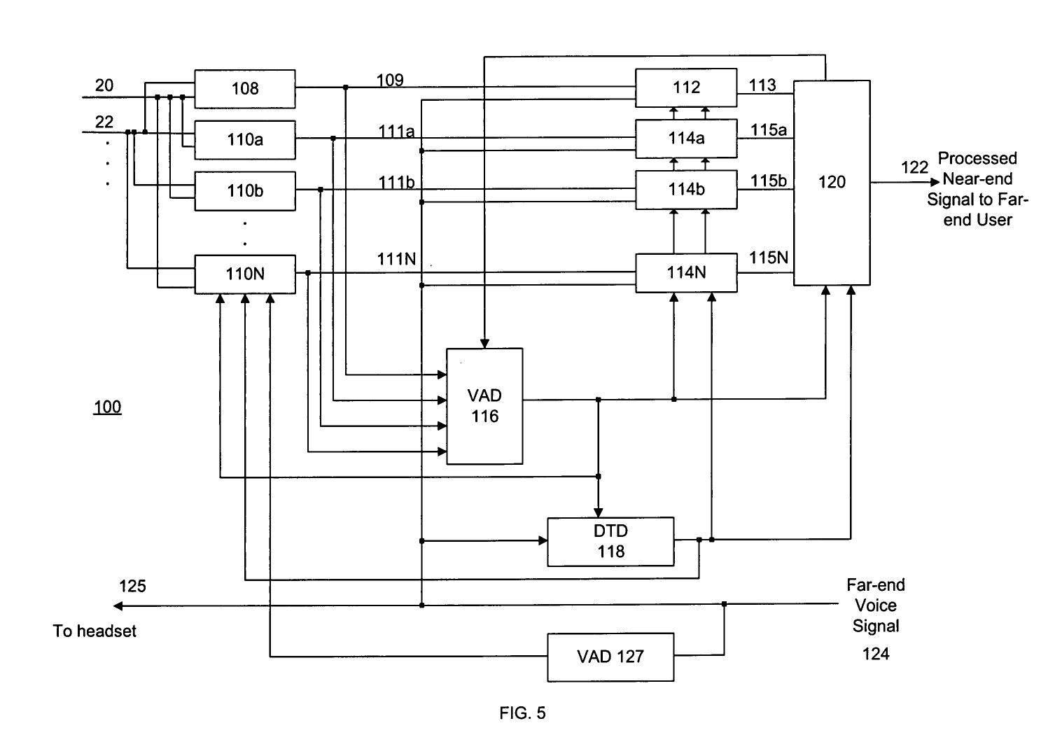

FIG. 5 illustrates one example of signal processing performed by a processing station 4. When multiple noise sources are present, blind source separation techniques are particularly effective in reducing noise. Referring to FIG. 5, an embodiment of the invention is shown illustrating an apparatus for noise reduction using blind source separation noise reduction. The apparatus receives individual digitized signals 20, 22 from a remote headset 2 and includes a beamform voice processor 108, beamform noise processor 110a, beamform noise processor 110b, . . . beamform noise processor 110N, voice echo controller 112, noise echo controller 114a, noise echo controller 114b, . . . noise echo controller 114N, transmit voice activity detector 116, double talk detector 118, noise reducer 120, and far end receive voice activity detector 127. One of ordinary skill in the art will recognize that other architectures may be employed for the apparatus by changing the number or position of one or more of the various apparatus elements. Although only two digitized signals 20, 22 are shown, additional digitized signals may be processed.

The individual digitized signals 20, 22 are applied to beamform voice processor 108, beamform noise processor 110a, beamform noise processor 110b, . . . beamform noise processor 110N. Beamform voice processor 108 outputs enhanced voice signal 109 and beamform noise processor 110a, 110b, . . . , 110N outputs enhanced noise signal 111a, enhanced noise signal 111b, . . . , enhanced noise signal 111N respectively. The digitized output signals 20, 22 are electronically processed by beamform voice processor 108 and beamform noise processor 110 to emphasize sounds from a particular location and to de-emphasize sounds from other locations. Through the use of beamform noise processor 110a, beamform noise processor 110b, . . . , beamform noise processor 110N, remote microphones at a headset can be advantageously used to detect multiple point noise sources. Each beamform noise processor is used to focus on a different point noise source and can be updated rapidly to isolate additional noise sources so long as the number of noise sources is equal to or less than the number of noise beamformers N.

The output of beamform voice processor 108, enhanced voice signal 109, is also propagated along a voice processing path to voice echo controller 112. The output of beamform noise processor 110a, beamform noise processor 110b, . . . , beamform noise processor 110N is propagated along a noise processing path to noise echo controller 114a, noise echo controller 114b, . . . , noise echo controller 114N. Echo controlled voice signal 113 and echo controlled noise signal 115a, 115b, . . . , 115N are input to noise reducer 120.

Microphone 12 and 14 at the remote headset receive signals from a voice source and one or more noise sources. The noise reducer 120 includes a blind source separation algorithm, as further described herein, that separates the signals of the noise sources from the different mixtures of the signals received by each microphone 12 and 14. In further example, a microphone array with greater than two microphones is utilized, with each individual microphone output being processed. The blind source separation process separates the mixed signals into separate signals of the noise sources, generating a separate model for each noise source utilizing noise signal 115a, 115 b, . . . 115N.

The output of noise reducer 120 is a processed signal 122 which has substantially isolated voice and reduced noise and echo due to the beamforming, echo cancellation, and noise reduction techniques described herein. Processed signal 122 is sent to a far-end user.

This example uses the features provided from several different signal processing technologies in a synergistic combination to provide an optimal voice output with minimal microphone background noise and minimal acoustic echo from the far end voice signal 124. A judicious combination of signal processing technologies is utilized with a remote microphone array to provide optimal echo control and background noise reduction in the transmit output signal sent to a far-end user.

In a further example of the invention, the input data is converted from the time domain to the frequency domain utilizing an algorithm such as a Fast Fourier Transform (FFT). In the frequency domain the convolved processes of beamforming, echo control and noise reduction become simple addition functions instead of convolutions. In this embodiment the output of the final frequency domain step is transformed back to the time domain via an algorithm such as an Inverse Fast Fourier Transform (IFFT). Commercially available digital signal processor such as dsp factory's BelaSigna family, Texas Instruments TMS320C5400 family or Analog Devices ADSP 8190 family of products can be utilized to efficiently implement frequency domain processing and the required domain transforms.

Furthermore, the echo controller functions and beamforming function can be reversed and still operate within the spirit of the invention, as both functions are linear or near-linear operations. The advantage of one configuration, as opposed to the other, is the number of echo controller functions to be implemented is equal to the number of microphones.

Beamformers, echo controllers and noise reducers can be implemented as separate stages or convolved together in any combination as a single stage when implemented as linear processes. Convolving them together has the advantage of reducing the amount of processing required in the implementation, which reduces the cost, and it can reduce the end-to-end delay, also known as latency, of the implementation. This is useful for user comfort in telephony applications. Convolving them together requires a greater dynamic range. Commercially available digital signal processors such as processors in Texas Instruments family TMS 320C54xx or Analog devices ADSP family 819x can be utilized to implement the required signal processing.

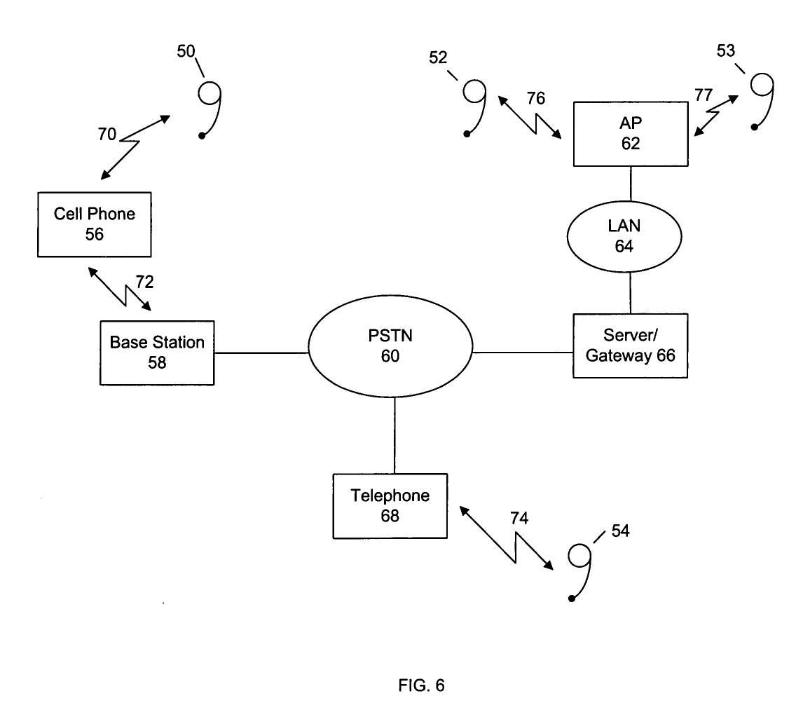

FIG. 6 illustrates examples of telephone networks in which the present invention may be implemented. In one example configuration, a wireless headset 50 and a cell phone 56 establish short range wireless communications using a Bluetooth wireless link 70. Cell phone 56 establishes wireless communications with a cellular base station 58 using a wireless protocol such as CDMA, GSM or other cellular standard known in the art. Base station 58 is coupled to a public switched telephone network (PSTN) node 60 for communication with a far-end user. In operation, wireless headset 50 transmits multiple channels of acoustic data over Bluetooth wireless link 70 to cell phone 56. Cell phone 56 acts as a processing station as described herein to receive and process the multiple channels of acoustic data.

In a further example configuration, a wireless headset 54 and a landline telephone 68 establish short range wireless communications using a wireless link 74. For example, wireless link 74 may be a DECT link. Although a DECT link is described, the wireless link 74 between the wireless headset 54 and landline telephone 68 may utilize any protocol capable of transmitting multiple channels of acoustic data, including for example, Bluetooth. Landline telephone 68 is coupled to PSTN node 60 for communication with a far-end user. In operation, wireless headset 54 transmits multiple channels of acoustic data over wireless link 70 to landline telephone 68. Alternatively, wireless headset 54 may transmit multiple acoustic signals over a single high bandwidth channel. Landline telephone 68 is a processing station which receives and processes the multiple channels of acoustic data to generate a processed signal that is transmitted to the PSTN node 60. Landline telephone 68 may include integrated hardware and software for performing the desired processing or may have a separate base station coupled to it. The DECT link may be utilized in a variety of application configurations, including for example cordless private branch exchange, wireless local loop, and GSM/DECT internetworking.

In a further example, a wireless headset 52 and an 802.11 access point (AP) 62 establish short range wireless communications using an 802.11 wireless link 76. AP 62 may, for example, be a personal computer. Multiple acoustic signals are transmitted on the 802.11 wireless link 76 to AP 62 for processing. 802.11 access point 62 is connected to a LAN cloud 64 via a wired line. The system may further include a server/gateway 66 provided between LAN cloud 64 and PSTN node 60. A wireless headset 53 may also establish short range wireless communications with AP 62 using an 802.11 wireless link 77. AP 62 may therefore process multiple acoustic signals from more than one headset. Headset 52 and headset 53 both utilize 802.11 access point 62 and are therefore within a proximate geographic distance from each other defined by the 802.11 network parameters.

802.11 chipmakers include Intersil, Agere (Lucent), and Texas Instruments. Manufacturers of 802.11 access points include Orinco (e.g., AP 1000 Access Point) and Nokia (e.g., A032 Access Point). One of ordinary skill in the art will recognize that other Bluetooth, DECT and 802.11 architectures may be employed for the networks described herein by changing the position of one or more of the various network elements.

The various examples described above are provided by way of illustration only and should not be construed to limit the invention. For example, although processing related to acoustic signals and noise reduction is described, the systems and methods described can also be applied where correlation of multiple channels of any type of data, either analog or digital, is sent from one or more remote devices to one or more other devices for processing. Additional example applications include voice recognition for security and voice matching, voice dialing, and voice and video correlation.

Based on the above discussion and illustrations, those skilled in the art will readily recognize that various modifications and changes may be made to the present invention without strictly following the exemplary embodiments and applications illustrated and described herein. Such changes may include, but are not necessarily limited to: location of wireless communication modules or other components of the mobile communication device; versions and features of the Bluetooth version used, including Bluetooth enhanced data rate (EDR); number, placement, and functions performed by the user interface; wireless communication technologies or standards to perform the communication link between the mobile communication device and processing station; signal processors used; 802.11 access points used. The method of transmitting multiple acoustic signals from the mobile communication device to the processing station may vary in additional examples of the invention. For example, multiple channels or single channels of varying bandwidth may be used. Such modifications and changes do not depart from the true spirit and scope of the present invention that is set forth in the following claims.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

1. A system for processing multiple acoustic signals comprising:
a mobile communication device comprising:
a first microphone for receiving a first acoustic signal;
a second microphone for receiving a second acoustic signal;
a device memory storing instructions that when executed by the mobile communication device cause the mobile communication device to wirelessly transmit both the first acoustic signal and the second acoustic signal to a signal processing station;
a first transceiver for transmitting the first acoustic signal and transmitting the second acoustic signal utilizing a wireless protocol;
a signal processing station comprising:
a second transceiver for receiving the first acoustic signal and the second acoustic signal utilizing the wireless protocol; and
a station memory storing instructions that when executed by the signal processing station cause the signal processing station to receive both the first acoustic signal and the second acoustic signal from the mobile communication device, and cause the signal processing station to process the first acoustic signal and the second acoustic signal to output a processed signal.

2. The system of claim 1, wherein the first acoustic signal is transmitted on a first channel and the second acoustic signal is transmitted on a second channel, the first channel and the second channel both between the mobile communication device and the signal processing station.

3. The system of claim 1, wherein the wireless protocol is Bluetooth.

4. The system of claim 1, wherein the wireless protocol is IEEE 802.11.

5. The system of claim 1, wherein the wireless protocol is the Digital Enhanced Cordless Telecommunications standard.

6. The system of claim 1, wherein the mobile communication device is a wireless headset.

7. The system of claim 1, wherein the signal processing station is a cellular telephone.

8. The system of claim 1, wherein the signal processing station is a personal computer.

9. The system of claim 1, wherein the signal processing station is an access point.

10. The system of claim 9, wherein the access point is connected to a local area network.

11. The system of claim 1, wherein the signal processing station is a base station coupled to a public switched telephone network system landline telephone.

12. The system of claim 1, wherein the signal processor implements a noise reduction algorithm to output a processed signal with reduced noise.

13. The system of claim 12, wherein the noise reduction algorithm uses noise subtraction, spectral subtraction, or independent component analysis.

14. The system of claim 1, wherein the signal processor comprises:
a voice processing path having an input to receive the first acoustic signal and the second acoustic signal, wherein the voice processing path is adapted to detect voice signals;
a noise processing path having an input to receive the first acoustic signal and the second acoustic signal, wherein the noise processing path is adapted to detect noise signals;
a first echo controller coupled to the voice processing path; and
a second echo controller coupled to the noise processing path, wherein the noise reducer is coupled to the output of the first echo controller and second echo controller.

15. A system for processing multiple acoustic signals comprising:
a mobile communication device comprising:
a first microphone for receiving a first acoustic signal, the first acoustic signal including a first voice signal component and a first noise signal component;
a second microphone for receiving a second acoustic signal, the second acoustic signal including a second voice signal component and a second noise signal component;
a device memory storing instructions that when executed by the mobile communication device cause the mobile communication device to wirelessly transmit both the first acoustic signal and the second acoustic signal;
a first transceiver for transmitting the first acoustic signal and transmitting the second acoustic signal utilizing a wireless protocol;
a signal processing station comprising:
a second transceiver for receiving the first acoustic signal and the second acoustic signal utilizing the wireless protocol; and
a station memory storing instructions that when executed by the signal processing station cause the signal processing station to receive both the first acoustic signal and the second acoustic signal from the mobile communication device, and cause the signal processing station to process the first acoustic signal and the second acoustic signal to output a processed voice signal with reduced noise.

16. The system of claim 15, wherein the first acoustic signal is transmitted on a first channel and the second acoustic signal is transmitted on a second channel.

17. The system of claim 15, wherein the wireless protocol is Bluetooth.

18. The system of claim 15, wherein the wireless protocol is IEEE 802.11.

19. The system of claim 15, wherein the wireless protocol is the Digital Enhanced Cordless Telecommunications standard.

20. The system of claim 15, wherein the mobile communication device is a wireless headset.

21. The system of claim 15, wherein the signal processing station is a cellular telephone.

22. The system of claim 15, wherein the signal processing station is a personal computer.

23. The system of claim 15, wherein the signal processing station is an access point.

24. The system of claim 15, wherein the signal processing station is a base station coupled to a public switched telephone network system landline telephone.

25. The system of claim 15, wherein the noise reduction processor uses noise subtraction, spectral subtraction, or independent component analysis.

26. A method for processing multiple acoustic signals to reduce undesired noise, the method comprising:
receiving a first acoustic signal at a mobile communication device with a first microphone;
receiving a second acoustic signal at the mobile communication device with a second microphone; and
transmitting from the mobile communication device both the first acoustic signal and the second acoustic signal for processing to a remote processing station using a wireless protocol.

27. The method of claim 26, wherein transmitting the first acoustic signal and the second acoustic signal for processing comprises transmitting the first acoustic signal on a first channel and transmitting the second acoustic signal on a second channel.

28. A method for processing multiple acoustic signals to reduce undesired noise, the method comprising:
receiving a first acoustic signal and a second acoustic signal at a processing station from a remote mobile communication device with a first microphone and a second microphone; and
processing the first acoustic signal and the second acoustic signal at the processing station to output a processed acoustic signal with reduced noise.

29. The method of claim 28, wherein receiving a first acoustic signal and a second acoustic signal at a processing station comprises receiving the first acoustic signal on a first channel and receiving the second acoustic signal on a second channel.
